(19) United States
(12) Patent Application Publication
(10) Pub. No.: US 2003/0042313 A1
(43) Pub. Date: Mar. 6, 2003

(54) Method and system for acquiring bar code encoded information

(76) Inventors: Joel Kahn, Rockville Centre, NY (US); Patrick Salatto JR., Miller Place, NY (US); Diana J. Melick, Ronkonkoma, NY (US); Stephen J. Schellhammer, Lake Grove, NY (US); Sean A. Connolly, Stony Brook, NY (US); Frank Boccuzzi, Brooklyn, NY (US)

Correspondence Address: Kirschstein, Ottinger, Israel & Schiffmiller, P.C., 489 Fifth Avenue, New York, NY, 10017-6105, US

(21) Appl. No.: 09/941,139

(22) Filed: Aug. 28, 2001

(51) Int. Cl. G06K 7/10

(52) U.S. Cl. 235/462.46

(57) ABSTRACT

A method and system for acquiring bar code encoded information wherein a bar code is read using a portable bar code reader to produce bar code data which has a wireless communications transceiver for transmitting the bar code data. The bar code data is transmitted to a second bar code reader which has a wireless communications transceiver for receiving bar code data and has an output circuit for communicating bar code data by a cable to a host computer. The bar code data and additional bar code data produced by the second bar code reader is communicated by the cable or by a secondary wireless connection to the host computer.

### BACKGROUND OF THE INVENTION

The present invention relates to a method and system for acquiring bar code encoded information.

Various optical readers and optical scanning systems have been developed heretofore for reading indicia such as bar code symbols appearing on the label or on the surface of an article. The symbol itself is a coded pattern of indicia comprised of, for example, a series of bars of various widths spaced apart from one another so bound spaces of various widths, the bars and spaces having different light reflecting characteristics. The readers in scanning systems electro-optically transform the graphic indicia into electrical signals, which are decoded into alphanumeric characters that are intended to be descriptive of the article or some characteristic thereof. Such characteristics are typically represented in digital form and utilized as an input to a data processing, system for applications in point-of-sale processing, inventory control and the like. Scanning systems of this general type have been disclosed, for example, in U.S. Pat. Nos. 4,251,798; 4,369,361; 4,387,297; 4,409,470; 4,760,248; 4,896,026, all of which have been assigned to the same assignee as the instant application. As disclosed in the above patents, such scanning systems includes, inter alia, fixed mount scanners, sometimes referred to as slot scanners, presentation scanners, scan engines or modules, and hand held, portable laser scanning devices supported by a user, which are configured to allow the user to aim the scanning head of the device, and more particularly, a light beam, at a targeted symbol to be read.

Such devices generally incorporate a light-receiving module which receives the light that has been reflected from the bar code symbol and determines, from the reflected pattern, the sequences of bars and spaces within the symbol. The unit may also incorporate decoding circuitry to decode the received information and to recover the underlying data (for example the alphanumeric data) which the bar code symbol represents.

U.S. Pat. Nos. 5,543,610, 6,036,098 and 6,101,483 also disclose other types of scanning devices, such as ring scanners, pen scanners and scanners that are built into or added onto personal digital assistants (PDA). These scanners, as well as the aforementioned scanners, also have the ability to transmit data relating to the bar code being scanned, for example, digital data relating to the bar code image itself or, where the decoder is also built into the scanner, the data encoded in the bar code.

Various protocols for the wireless transmission of data are known, including RF wireless transmissions, IRDA, BlueTooth and others. Examples of scanners using such wireless transmission protocols are Symbol Technologies LS4071, NSA1040, P370, P470 and PCK9140.

It would be desirable to use portable scanners, which have wireless communication capabilities, along with scanners such as handheld or slot scanners, that have a wired connection to a host computer terminal or point of sale terminal.

### SUMMARY OF THE INVENTION

The main object of the present invention is to provide a method for acquiring bar code encoded information, wherein bar code data is transmitted by a portable bar code reader via a wireless communications protocol to another bar code reader that is connected via a cable to a host computer.

Another object of the invention is to provide a method wherein the host computer receives bar code data from the portable bar code reader, as well as bar code data produced by the other bar code reader which has the wired connection.

In accordance with the invention, the wireless communications transceiver can be an RF wireless transceiver, a BlueTooth transceiver or an IRDA wireless transceiver. The portable bar code reader can be a ring scanner, a pen scanner, a PDA scanner, a keyfob type scanner, a hand-holdable scanner such as the Symbol LS9100 or M2000 or a handheld scanner. The other bar code reader which has the wired connection to the host computer can be a handheld scanner or a fixed mount scanner, such as a slot scanner, price checker or kiosk.

In a preferred embodiment of the present invention, the bar code reader which has the wired connection to the host has the wireless transceiver built into it. The host computer can be a computer terminal, a point of sale terminal or a wireless terminal which communicates with a wired terminal/access point via secondary wireless methods, acting as a gateway into the host computer. The decoding can be either in either or both scanners or in the host or a combination thereof.

A further object is to provide a system at least one portable bar code scanner has a wireless communications transceiver, and a second bar code scanner has a wireless communications transceiver for receiving bar code from the portable bar code reader has an output circuit which communicates bar code data from it and the portable bar code reader via a cable to a host computer.

These and other features and embodiments of the present invention will become more apparent from the following detailed description of the invention taken with the attached drawings.

### BRIEF DESCRIPTION OF THE DRAWINGS

FIG. 1 is a schematic diagram of the system for carrying out the present invention; and

FIG. 2 shows a slot scanner of FIG. 1 in accordance with the present invention.

### DETAILED DESCRIPTION OF THE INVENTION

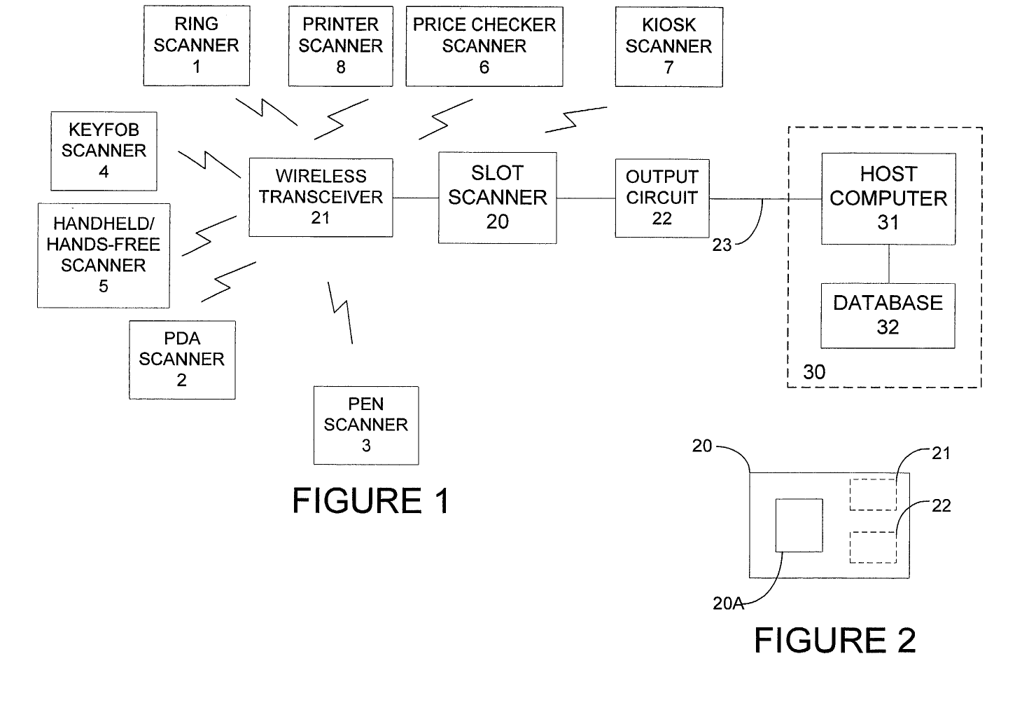

Referring now to FIG. 1, the system according to the present invention may comprise one or more portable bar code readers shown by way of example as ring scanner 1, PDA scanner 2, pen scanner 3, keyfob scanner 4, handheld/hands-free presentation scanner 5, a pricechecker scanner 6, a kiosk scanner 7 and a printer based scanner 8. Examples of commercial devices of this type are Symbol Infopen, SPT-1700 and SPT-1500. Each of these devices have a wireless transceiver therein which is capable of communicating with a similar wireless transceiver 21 which is connected to a wired scanner which is shown to be slot scanner 20. The wireless transceivers for the standard protocols such as IRDA and BlueTooth are off the shelf integrated circuits. Examples can be found at www.irda.org and at www.bluetooth.com. As shown in FIG. 2, slot scanner 20 has a window 20A over which a bar coded item is passed for reading same and has the wireless transceiver 21 and output circuit 22 built into it. While a slot scanner 20 is shown by way of example, it is understood that other types of scanners, such as a handheld scanner or a presentation scanner, can be used in its place with the output circuitry and wireless transceiver built therein.

Scanner 20 is connected via the output circuit to a host 30, which in the embodiment shown, includes a host computer 31 connected to a database 32. For example, the output circuit 22 can be an RS232, USB or Synapse port which connects via the cable 23 to an RS232 input in computer 31. Bar code data that is read by the slot scanner 20 is passed to the host computer 31 which looks up the encoded data from the bar code in the database, so as to indicate the item that was scanned and the price or other characteristics related to the item for display to the customer and for printing on a receipt.

Bar code information read by ring scanner 1 is transmitted via the wireless transceiver in the scanner to wireless transceiver 21 and sent via output circuit 22 to the host computer 31 as if it had been read by slot scanner 20. The host computer uses database 32 to look up the information relating to the read bar code.

The decoding of the bar code data can either take place in the ring scanner, PDA scanner or pen scanner, or slot scanner 20 can have the decoder, and the decoder can be used to decode information from the scanners 1-3. Alternatively, all of the decoding can take place in the host computer 31.

The host computer 31 can also be a computer terminal or a point of sale terminal, such as a cash register in a store. Examples of point of sale terminals are IBM Sure POS 730 and 750, IBM Sure 1, NCR 7052 and ICL 9520 PCPOS.

It is understood that the embodiments described hereinabove are merely illustrative and are not intended to limit the scope of the invention. It is realized that various changes, alterations, rearrangements and modifications can be made by those skilled in the art without substantially departing from the spirit and scope of the present invention.

What is claimed is:

1. A method for acquiring bar code encoded information comprising the steps of:
reading a bar code using a portable bar code reader to produce bar code data and having a wireless communications transceiver for transmitting the bar code data;
transmitting the bar code data to another bar code reader having a wireless communications transceiver for receiving bar code data and having an output circuit for communicating bar code data by a cable to a host computer; and
communicating the bar code data via the cable to the host computer.

2. The method according to claim 1, wherein the wireless communications transceiver is an RF wireless transceiver.

3. The method according to claim 1, wherein the wireless communications transceiver is a BlueTooth wireless transceiver.

4. The method according to claim 1, wherein the wireless communications transceiver is a 802.11 WLAN wireless transceiver.

5. The method according to claim 1, wherein the wireless communications transceiver is an IRDA wireless transceiver.

6. The method according to claim 1, wherein the portable bar code reader is a ring scanner.

7. The method according to claim 1, wherein the portable bar code reader is a hand held scanner.

8. The method according to claim 1, wherein said another bar code reader is a slot scanner.

9. The method according to claim 1, wherein said another bar code reader is a presentation scanner.

10. The method according to claim 1, wherein said another bar code reader is a hand held scanner.

11. The method according to claim 1, wherein the transceiver is built into said another reader.

12. The method according to claim 1, wherein the host computer is a wired computer terminal.

13. The method according to claim 1, wherein the host computer is a wireless computer terminal.

14. The method according to claim 1, wherein the host computer is a point of sale terminal.

15. The method according to claim 1, wherein the host computer is a printer.

16. The method according to claim 1, further comprising decoding the bar code data in at least one of the portable reader, said another reader and the host computer.

17. A system for acquiring bar code encoded information comprising:
at least one portable bar code reader for producing bar code data in response to reading a bar code and having a wireless communications transceiver for transmitting the bar code data; and
a second bar code reader for producing bar code data in response to reading a bar code and having a wireless communications transceiver for receiving bar code data from the at least one portable bar code reader and an output circuit for communicating the bar code data received from the at least one portable bar code reader and bar code data produced by the second bar code reader by a cable to a host computer.

18. The system according to claim 17, wherein each wireless communications transceiver is an RF wireless transceiver.

19. The system according to claim 17, wherein each wireless communications transceiver is a BlueTooth wireless transceiver.

20. The system according to claim 17, wherein each wireless communications transceiver is a WLAN wireless transceiver.

21. The system according to claim 17, wherein each wireless communications transceiver is an IRDA wireless transceiver.

22. The system according to claim 17, wherein the at least one portable bar code reader is a ring scanner.

23. The system according to claim 17, wherein the at least one portable bar code reader is a hand held scanner.

24. The system according to claim 17, wherein said second bar code reader is a slot scanner.

25. The system according to claim 17, wherein said second bar code reader is a hand held scanner.

26. The system according to claim 17, wherein said second reader has the transceiver is disposed therein.

27. The system according to claim 17, wherein the host computer is a computer terminal.

28. The system according to claim 17, wherein the host computer is a point of sale terminal.

29. The system according to claim 17, further comprising a decoder for decoding the bar code data in at least one of the at least one portable reader, said second reader and the host computer.
